(19) United States
(12) Patent Application Publication
(10) Pub. No.: US 2016/0032992 A1
(43) Pub. Date: Feb. 4, 2016

(54) Light Weight Backing Plate for a Brake Pad

(71) Applicants: Robert Bosch LLC, Broadview, IL (US); Robert Bosch GmbH, Stuttgart (DE)

(72) Inventors: Hamidreza Mohseni, Skokie, IL (US); Robert T. Wilkes, Tinley Park, IL (US)

(21) Appl. No.: 14/810,593

(22) Filed: Jul. 28, 2015

Related U.S. Application Data
(60) Provisional application No. 62/030,738, filed on Jul. 30, 2014.

(51) Int. Cl. F16D 65/092; B22F 7/04; B22F 7/00

(52) U.S. Cl. CPC F16D 65/092; B22F 7/006; B22F 7/04; B22F 2007/042

(57) ABSTRACT

A backing plate for a brake assembly includes a first face sheet, a second face sheet generally parallel to the first face sheet, and a metal foam core at least partially encapsulated between the first and second face sheets.

### PRIORITY

This application claims the benefit of U.S. Provisional Patent Application No. 62/030,738 which was filed with the US. Patent and Trademark Office on Jul. 30, 2014, the disclosure of which is incorporated by reference herein in its entirety.

### TECHNICAL FIELD

This disclosure relates generally to vehicle parts, and, more particularly, to brake pad assemblies.

### BACKGROUND

Brake pads are one of the most consumable parts for vehicles, and have a significant influence on safety and operability of vehicles. Factors including brake pad longevity, durability, and weight can dramatically affect environmental and economic costs of vehicle production, operation, and maintenance. Brake pad design in terms of material and manufacturing method can also affect functionality, mechanical integrity, noise and vibration damping, and to a lesser extent it can help reduce fuel consumption, CO₂ emission, and environmental pollution.

Brake pad assemblies are utilized in a wide variety of vehicles, such as cars, trucks, airplanes, bicycles, and motorcycles. FIG. 1 illustrates a side view of a customary brake pad assembly 10 for a motor vehicle, and FIG. 2 illustrates a cross-section view of the brake pad assembly of FIG. 1. The brake pad assembly 10 includes a pair of brake pads 12 positioned on opposite sides of a rotating body such as a brake disk 14 that rotates with a wheel 16. When actuated, such as by an actuator 18, a pushing member such as a caliper 20 pinches the brake disk 14 between the pair of brake pads 12 to apply a compression force resulting in friction that slows rotation of the wheel 16.

FIG. 3 illustrates a perspective view of a brake pad 12. Customarily, a brake pad 12 includes a pad of friction material 22 attached to a backing plate 24. A typical backing plate is a solid plate of steel, and includes approximately 50% of the net weight of the brake pad assembly. Decreasing the weight of the backing plate 24 can be desirable to, for example, increase fuel economy of a vehicle. However, prior weight reduction approaches have generally resulted in a decrease in the longevity and durability of the backing plate and/or brake pad.

Backing plates are desirably capable of withstanding the compressive forces of the brake pad assembly and shear forces caused by friction with the brake disk without substantial deformation, even in severe environmental conditions. Although the friction material 22 generally acts as a thermal insulator, backing plates may also be exposed to high temperatures, caused by, for example, heat produced by the friction during braking operations.

Additionally, in some circumstances, for example instances when the friction material 22 is worn or depleted, the backing plate 24 can come into direct contact with the brake disk 14, which can cause significant wear or damage to the backing plate 24 and brake disk 14. This can generate sparks and high temperatures, which can subsequently damages surrounding elements, or cause other adverse effects such as undesirable noise and vibration during operation and uncontrollable or unpredictable performance. In addition, backing plates are desirably resistant to other environmental effects such as corrosion due to salt spray and moisture, temperature fluctuations, vibration, etc.

Therefore, what is needed is a backing plate for a brake pad that exhibits low weight, while optimizing other factors including durability and longevity, without sacrificing other desirable or necessary properties of the brake pad.

### SUMMARY

In one embodiment, a backing plate for a brake assembly includes a first face sheet, a second face sheet generally parallel to the first face sheet, and a metal foam core at least partially encapsulated between the first and second face sheets.

In another embodiment, the backing plate further includes at least one margin region formed integrally with at least one of the first and second face sheets and positioned surrounding the metal foam core such that the margin region and the first and second face sheets at least partially encapsulate the metal foam core. In a further embodiment, the margin region and the first and second face sheets completely encapsulate the metal foam core.

In yet another embodiment, the metal foam core of the backing plate is chemically bonded to the first and second face sheets.

In one particular embodiment, a density of the metal foam core is less than or equal to 1 g/cm³.

In another embodiment, the metal foam core of the backing plate according to the disclosure is an aluminum foam core.

In a further embodiment, a method for producing a backing plate for a brake pad assembly includes mixing a metal powder with a foaming agent to form a mixture, compacting the mixture to form a compacted foamable semi-finished product and joining the compacted foamable semi-finished product with a first metal face sheet on a first side of the compacted foamable semi-finished product and a second metal face sheet on a second side of the compacted foamable semi-finished product to form a substantially sandwich-like structure. The method further includes shaping the substantially sandwich-like structure into a desired shape, heating the shaped substantially sandwich-like structure above a predetermined activation temperature of the foaming agent, and foaming the compacted foamable semi-finished product within the first and second metal sheets to form a metal foam core between the first and second metal face sheets.

In one embodiment of the method, the shaping further comprises stamping the substantially sandwich-like structure into the desired shape. In some embodiments, the joining further comprises forming at least one margin region on at least one side of the compacted foamable semi-finished product with at least one of the first and second metal face sheets, and the stamping further comprises wrapping the at least one margin region around the compacted foamable semi-finished product so as to at least partially encapsulate the foamable semi-finished product between the first and second metal face sheets and the at least one wrapped margin region. In another embodiment of the method, the joining further comprises joining a plurality of compacted foamable semi-finished products with the first and second metal face sheets to form a plurality of substantially sandwich-like structures and the stamping further comprises separating each individual substantially sandwich-like structure from the plurality of substantially sandwich-like structures.

In yet another embodiment of the method according to the disclosure, the mixing further comprises mixing an aluminum powder with the foaming agent to form the mixture.

In one embodiment of the method, the compacting further comprises compacting the mixture in a cold press to form the compacted foamable semi-finished product.

In another embodiment, the joining further comprises joining the compacted foamable semi-finished product to the first and second metal face sheets in a roll cladding process.

In some embodiments, the first and second metal face sheets are formed of steel.

In yet another embodiment of the method, the foaming further comprises chemically diffusing and bonding the foaming compacted foamable semi-finished product to the face sheets by heating the substantially sandwich-like structure to a temperature near a melting point of the metal powder.

In another embodiment according to the disclosure, a brake pad assembly includes a brake disk rotationally coupled to a rotating body and at least one brake pad. The at least one brake pad includes a friction material and a backing plate on which the friction material is mounted. The backing plate includes a first face sheet, a second face sheet generally parallel to the first face sheet, and a metal foam core at least partially encapsulated between the first and second face sheets.

In one embodiment, the backing plate of the brake pad assembly further comprises at least one margin region formed integrally with at least one of the first and second face sheets and positioned surrounding the metal foam core such that the at least one margin region and the first and second face sheets at least partially encapsulate the metal foam core.

In yet another embodiment of the brake pad assembly, the metal foam core is chemically bonded to the first and second face sheets.

In some embodiments, a density of the metal foam core is less than or equal to 1 g/cm³.

In another embodiment, the metal foam core is an aluminum foam core.

### BRIEF DESCRIPTION OF THE DRAWINGS

FIG. 1 is a side view of a typical brake pad assembly.

FIG. 2 is a cross-sectional view of the brake pad assembly of FIG. 1.

FIG. 3 is a perspective view of a typical brake pad.

FIG. 4 is a cross-sectional view of a backing plate for a brake pad, according to a described embodiment.

FIG. 5 is a top view of a backing plate according to another described embodiment having an irregular shape.

FIG. 6 is a cross-sectional view of the backing plate along line VI-VI of FIG. 5.

FIG. 7 is a flowchart of a method of producing a backing plate of a brake pad assembly according to the described embodiment.

FIG. 8A is a schematic illustration of mixing of the foaming agent and the metal powder of the method of FIG. 7.

FIG. 8B is a schematic illustration of cold pressing the mixture in the method of FIG. 7.

FIG. 8C is a schematic illustration of roll-cladding the compacted foamable semi-finished product in the method of FIG. 7.

FIG. 8D is a schematic illustration of the substantially sandwich-like structure in the method of FIG. 7.

FIG. 8E is a schematic illustration of the progressive stamping of the substantially sandwich-like structure in the method of FIG. 7.

FIG. 8F is a schematic illustration of the stamped substantially sandwich-like structure having wrapped ends in the method of FIG. 7.

FIG. 8G is a schematic illustration of the heating of the stamped substantially sandwich-like structure to obtain the final backing plate in the method of FIG. 7.

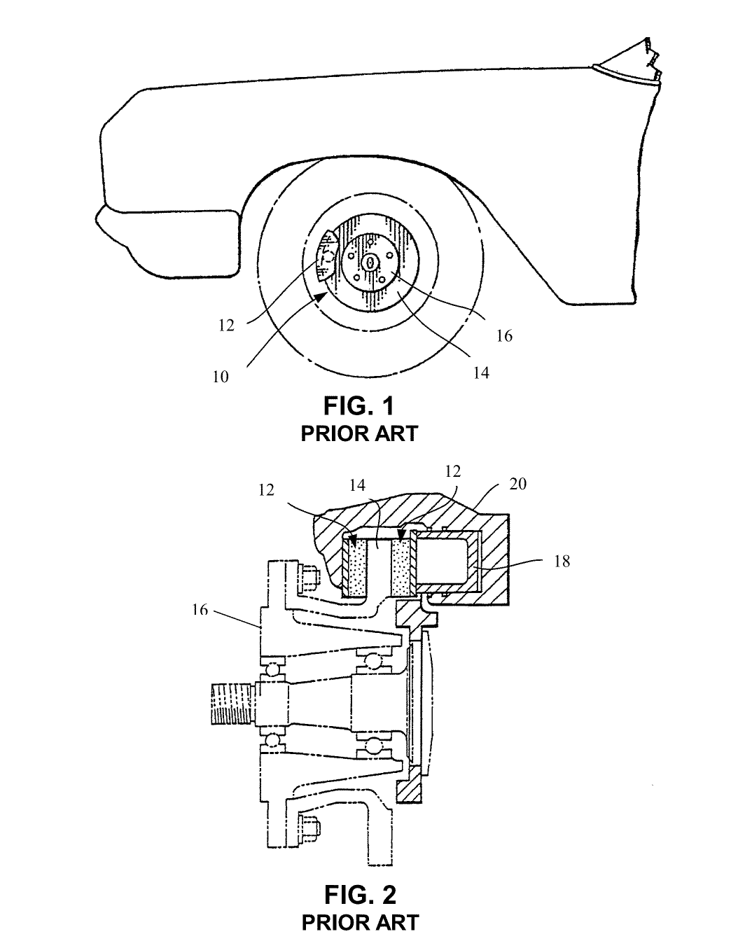

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

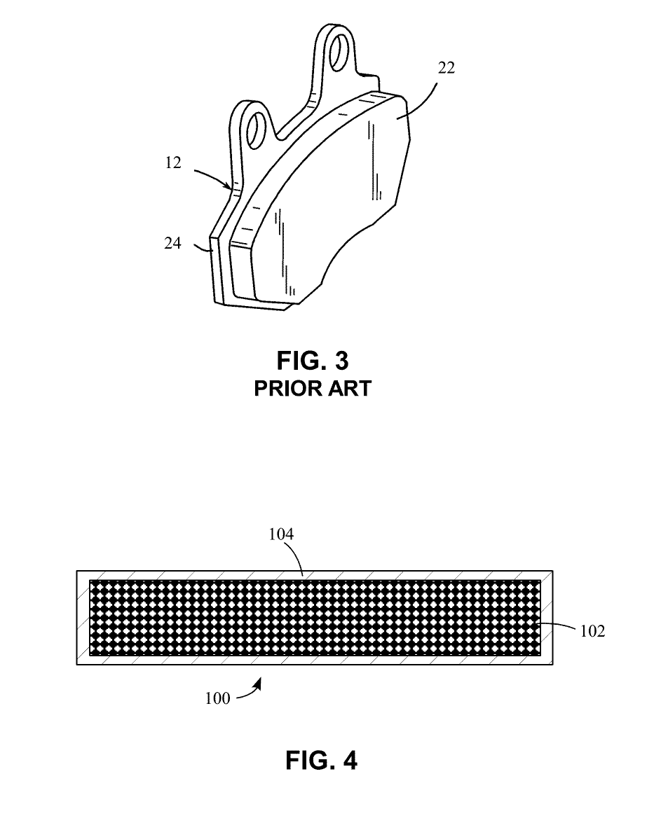

FIG. 4 depicts a cross-section view of a backing plate 100 for a brake pad according to an exemplary embodiment of the disclosure. The backing plate 100 is defined by a substantially sandwich-like structure that includes a metal foam core 102 between and encapsulated by face sheets 104. Relative to a solid metal backing plate, such as the steel backing plate 24 illustrated in FIG. 3, the backing plate 100 having the substantially sandwich-like structure has a reduced weight by a factor of, for example, 50% or more, a rigidity increased by a factor of about 10 or more, an increased mechanical damping factor, an increased sound absorption factor, increased thermal stability, and an increased stiffness to weight ratio.

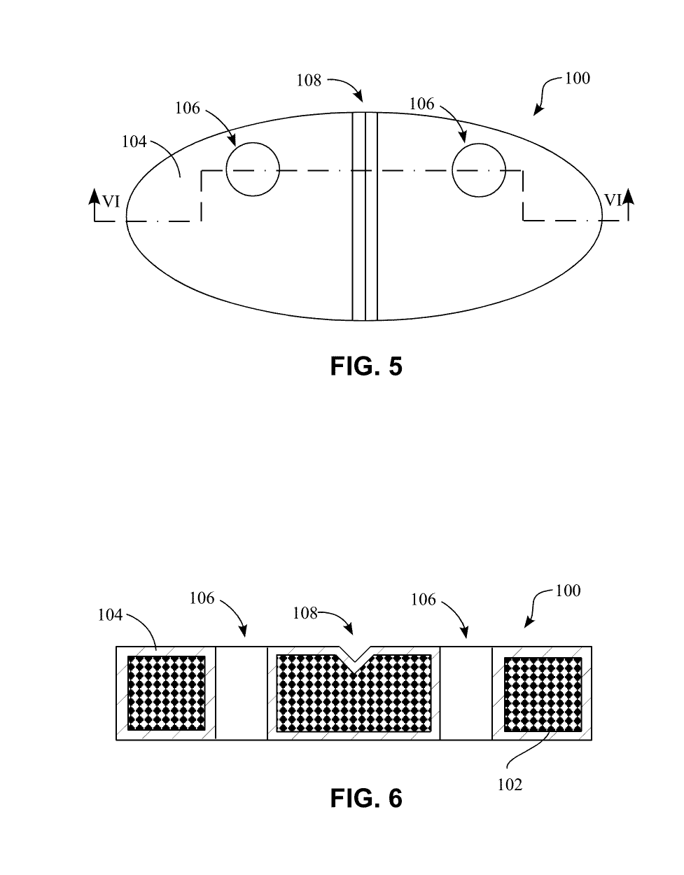

Although the backing plate 100 is illustrated in FIG. 4 as having a substantially regular rectangular shape, in should be understood that, in other embodiments, the backing plates according to the disclosure have an irregular shape, such as a shape configured to conform to a contour of other elements of a brake pad assembly such as a caliper, brake disk, etc. FIG. 5 illustrates top view, while FIG. 6 illustrates a cross section view along line VI-VI, of an embodiment of a brake pad 100 having an irregular shape that includes holes 106 and a surface depression 108. As illustrated in FIG. 6, the face sheets 104 are shaped such that the metal foam core 102 is not exposed to an outer surface of the backing plate 100, although in some embodiments, at least a portion of the metal foam core may be so exposed.

In one embodiment, the face sheets 104 are sheets of steel, although aluminum alloys or other metals, composite materials, and other materials are also contemplated. In one particular embodiment, the face sheets 104 have a thickness, ductility, and other properties adapted for forming in manufacturing methods such as roll cladding and progressive stamping. In one example, the face sheets 104 are steel sheets having a thickness of about 1.5 mm to about 15 mm, or more particularly, about 5 mm.

The metal foam core 102 is a class of materials exhibiting low density and favorable physical, mechanical, thermal and acoustic properties which are determined in part by the metal foam's density and internal structure, which in turn can depend upon various production processes. Metal foams can be based on a variety of metals, including aluminum, nickel, magnesium, lead, zinc, copper, bronze, titanium, steel, and gold. Ashby et al., “Metal Foams: A Design Guide” Butterworth-Heinemann, 2000, describes metal foam properties, production methods, and design considerations, and is incorporated herein by reference in its entirety. In one embodiment, the metal foam core 102 includes a porous aluminum foam, has a density of less than or equal to 1 g/cm³, and has a thickness of about 5 mm to about 50 mm, or more particularly, about 20 mm. In another embodiment, the metal foam core 102 may include semi-porous aluminum form with a density of less than or equal to 1 g/cm³.

Similar to FIG. 4, the face sheets 104 as illustrated in FIG. 5 encapsulate the metal foam core 102. The metal foam core 102 is bonded to the face sheets 104 via metallic bonds at an interface between the metal foam core 102 and the face sheets 104. Metallic bonds, such as bonds created via roll cladding, exhibit an increased thermal stability, mechanical integrity, and decreased risk of delamination relative to other types of resin-based metal joining methods, especially at elevated temperatures.

In one embodiment, the face sheets 104 and the metal foam core 102 are further joined by a chemical diffusion and bonding, which is induced, for example, via heating at the interface between the face sheets 104 and the metal foam core 102. The chemical diffusion and bonding increases mechanical strength, formability, stiffness, and integrity of the backing plate 100.

In another embodiment, the substantially sandwich-like structure of the backing plate 100 is configured to dampen noise and vibration. In doing so, backing plate 100 no longer requires a damping accessory such as a shim or back plate coating. In other words, no additional damping measures are required when the backing plate includes sufficient damping via the sandwich-like structure.

In one embodiment, the metal foam core 102 and the face sheets 104 are configured as physical interfaces for acoustic isolation and shock wave attenuation. In one embodiment, the backing plate 100 is configured to provide damage energy absorption, a high stiffness-to-weight ratio, and a high thermal stability.

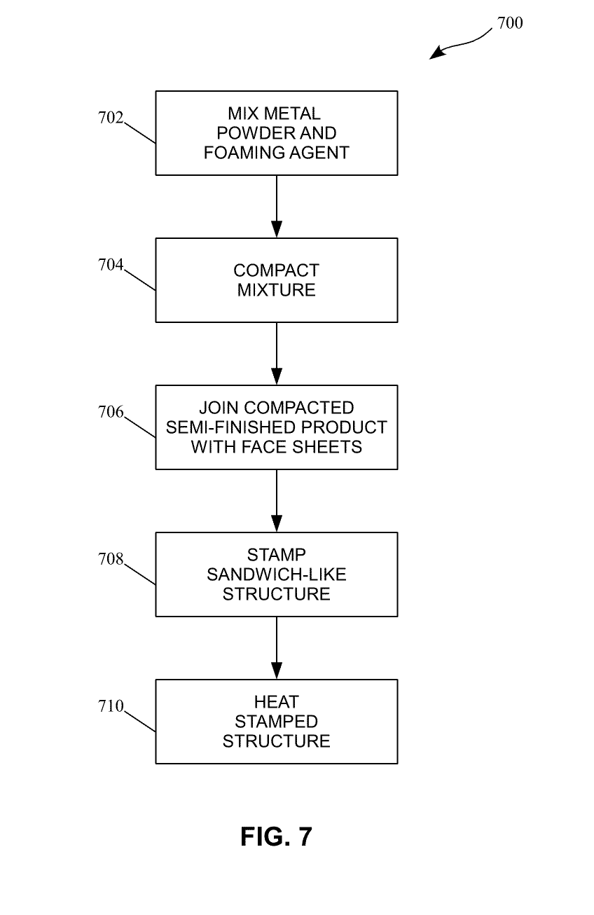

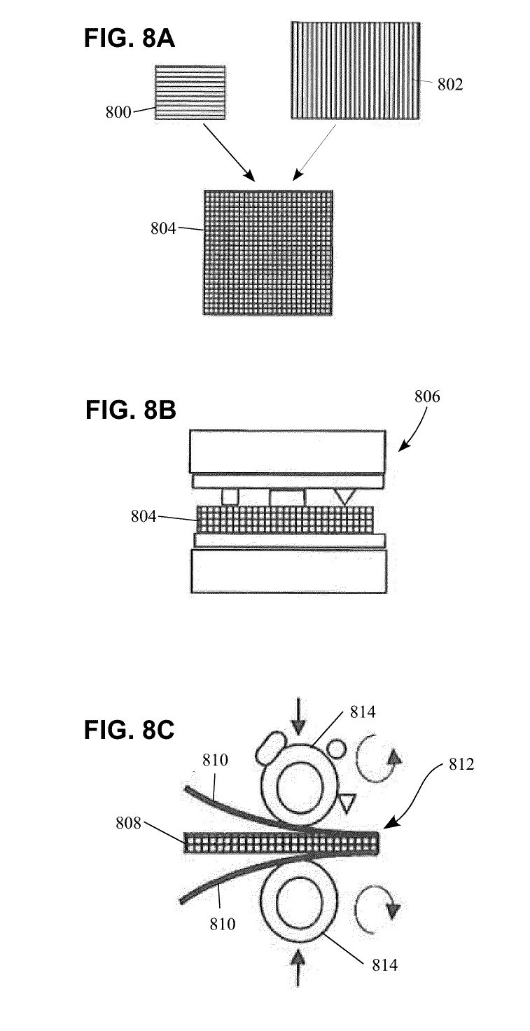

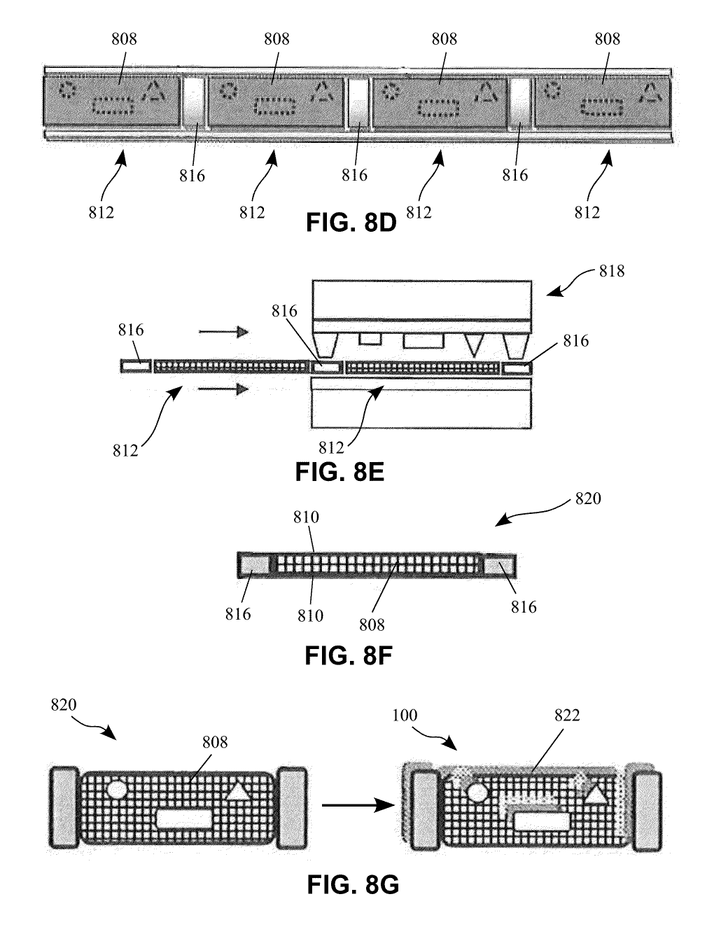

FIG. 7 illustrates a process diagram of a method 700 according to the exemplary embodiment of the disclosure of producing a backing plate for a brake pad, while FIGS. 8A-8G illustrate the backing plate at various points during the method 700. While the methodology is described as a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement the methodology described herein.

In the embodiment of the methodology 700 illustrated in FIG. 7, the methodology includes a powder metallurgy process in order to form the metal foam core, a roll cladding process to form the substantially sandwich-like structure, and a progressive stamping process to form a net shape of the backing plate 24. However, it should be understood that other processes of forming a metal foam, such as processes described in Ashby et al., may also be utilized. U.S. Pat. No. 5,151,246, issued Sep. 29, 1992 to Baumeister et al. describes methods of manufacturing foamable metal bodies, the disclosure of which is incorporated by reference herein in its entirety.

The method 700 begins at block 702 with the mixing of a metal powder 800 (FIG. 8A) and a foaming agent 802 into a mixture 804. In one embodiment, the mixing is performed homogenously via a powder metallurgy process so as to form a homogenous mixture 804. In another embodiment, the mixing of the metal powder 800 and the foaming agent 802 is performed non-homogenously. At block 704, the mixture 804 of the metal powder 800 and foaming agent 802 is compacted using, for example, a cold press 806 (FIG. 8B). In some embodiments, other compacting processes are utilized to densify the mixture in place of cold pressing, such as uniaxial compaction, powder extrusion, roll compaction and cold and/or hot isostatic pressing. After compaction, the mixture becomes a compacted foamable semi-finished product 808 (FIG. 8C).

As illustrated in FIG. 8C, the compacted foamable semi-finished product 808 is then joined with face sheets 810 to form a substantially sandwich-like structure 812 (block 706). In one embodiment, the compacted foamable semi-finished product 808 and the face sheets 810 are joined via a roll cladding process in which two rolls 814 press the face sheets 810 to both sides of the compacted foamable semi-finished product 808. In one embodiment, the face sheets 810 of the sandwich-like structure are substantially parallel with one another such that the face sheets 810 are in planes that are within 5 degrees of parallel with one another. In one particular embodiment, the face sheets 810 are parallel with one another.

In another embodiment, a single metal sheet is used to form the face sheets 810 on both sides of the compacted foamable semi-finished product 808. For example, the metal sheet is joined to one side of the compacted foamable semi-finished product 808 via the process to form the first face sheet 810. The same metal sheet continues around the compacted foamable semi-finished product 808 and joins to the second side of the compacted foamable semi-finished product 808 to form the second face sheet 810 via the same process, a separate process identical to the earlier process, or a different process.

As shown in FIG. 8D, a margin region 816 of the face sheets 810 is advantageously included on each opposing end of the substantially sandwich-like structure 812 in order to account for a disparity between mechanical properties and stamping behaviors of the face sheets 810 and the compacted foamable semi-finished product 808. As will be discussed in further detail below, the inclusion of the margins 816 facilitate the final progressive stamping process and near-net shaping production.

FIG. 8D also illustrates that, in some embodiments, the method 700 of FIG. 7 is used to produce a series of backing plates. In such an embodiment, a plurality of substantially sandwich-like structures 812 are produced in series at block 706 by producing a margin region 816 in the face sheets 810 between each pair of substantially sandwich-like structures 812. Further processing is applied to each substantially sandwich-like structure 812 in the series, thereby facilitating production of a plurality of backing plates in an efficient and timely manner.

As depicted in FIG. 8E, the sandwich-like structures 812 are then fed sequentially into a progressive stamping machine 818 to be stamped (block 708). The progressive stamping process stamps the substantially sandwich-like structures 812 into a desired shape of the backing plate for the brake pad assembly. The stamping process (block 708) also serves to separate the sandwich-like structures 812 from one another in the margin regions 816. Optionally, the progressive stamping process forms and wraps at least one of the margin regions 816 around the substantially sandwich-like structure 812 so that the compacted foamable semi-finished product 808 is encapsulated by the face sheets 810. In one embodiment, the compacted foamable semi-finished product 808 is completely encapsulated by the face sheets 810 and the margin regions 816, as illustrated by the stamped substantially sandwich-like structure 820 shown in FIG. 8F. In another embodiment, the compacted foamable semi-finished product 808 is partially encapsulated by the face sheets 810 such that one or more sides of the compacted foamable semi-finished product 808 are not covered by the face sheets 810. In some embodiments, the progressive stamping includes, for example, forming the backing plate into an irregular shape, and forming holes and/or other features such as curves or depressions in the backing plate.

In the described embodiment, the foaming agent 802 is configured to activate when heated to a predetermined temperature. As such, at block 710, the stamped substantially sandwich-like structure is heated to a temperature that is equal to or greater than the predetermined temperature (FIG. 8G). In one embodiment, the stamped substantially sandwich-like structure 820 is heated to a temperature near to, but below, the melting point of the metal powder. In one particular embodiment, the stamped substantially sandwich-like structure is heated to a temperature between 1° C. and 20° C. less than the melting point of the metal powder. As a result of activation of the foaming agent, the compacted foamable semi-finished product 808 expands into a metal foam 822, producing the final backing plate 100. The metal foam 822 is a highly porous cellular solid with a closed-pore structure.

Additionally, during the heating (block 710), chemical diffusion and bonding occurs between the metal foam 822 as it forms and the face sheets 810 due to heating at the interface between the face sheets 810 and the metal foam 822. The chemical diffusion and bonding increases mechanical strength, formability, stiffness, and integrity of the backing plate 100.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the disclosure.

1. A backing plate for a brake assembly comprising:
a first face sheet;
a second face sheet generally parallel to the first face sheet; and
a metal foam core at least partially encapsulated between the first and second face sheets.

2. The backing plate of claim 1, further comprising:
at least one margin region formed integrally with at least one of the first and second face sheets and positioned surrounding the metal foam core such that the margin region and the first and second face sheets at least partially encapsulate the metal foam core.

3. The backing plate of claim 2, wherein the margin region and the first and second face sheets completely encapsulate the metal foam core.

4. The backing plate of claim 1, wherein the metal foam core is chemically bonded to the first and second face sheets.

5. The backing plate of claim 1, wherein a density of the metal foam core is less than or equal to 1 g/cm³.

6. The backing plate of claim 1, wherein the metal foam core is an aluminum foam core.

7. A method for producing a backing plate for a brake pad assembly comprising:
mixing a metal powder with a foaming agent to form a mixture;
compacting the mixture to form a compacted foamable semi-finished product;
joining the compacted foamable semi-finished product with a first metal face sheet on a first side of the compacted foamable semi-finished product and a second metal face sheet on a second side of the compacted foamable semi-finished product to form a substantially sandwich-like structure;
shaping the substantially sandwich-like structure into a desired shape;
heating the shaped substantially sandwich-like structure above a predetermined activation temperature of the foaming agent; and
foaming the compacted foamable semi-finished product within the first and second metal sheets to form a metal foam core between the first and second metal face sheets.

8. The method of claim 7 wherein the shaping further comprises stamping the substantially sandwich-like structure into the desired shape.

9. The method of claim 8 wherein:
the joining further comprises forming at least one margin region on at least one side of the compacted foamable semi-finished product with at least one of the first and second metal face sheets; and
the stamping further comprises wrapping the at least one margin region around the compacted foamable semi-finished product so as to at least partially encapsulate the foamable semi-finished product between the first and second metal face sheets and the at least one wrapped margin region.

10. The method of claim 9, wherein:
the joining further comprises joining a plurality of compacted foamable semi-finished products with the first and second metal face sheets to form a plurality of substantially sandwich-like structures; and
the stamping further comprises separating each individual substantially sandwich-like structure from the plurality of substantially sandwich-like structures.

11. The method of claim 7 wherein the mixing further comprises mixing an aluminum powder with the foaming agent to form the mixture.

12. The method of claim 7 wherein the compacting further comprises compacting the mixture in a cold press to form the compacted foamable semi-finished product.

13. The method of claim 7 wherein the joining further comprises joining the compacted foamable semi-finished product to the first and second metal face sheets in a roll cladding process.

14. The method of claim 7, wherein the first and second metal face sheets are formed of steel.

15. The method of claim 7 wherein the foaming further comprises chemically diffusing and bonding the foaming compacted foamable semi-finished product to the face sheets by heating the substantially sandwich-like structure to a temperature near a melting point of the metal powder.

16. A brake pad assembly comprising:
a brake disk rotationally coupled to a rotating body; and
at least one brake pad including a friction material and a backing plate on which the friction material is mounted, the backing plate including a first face sheet, a second face sheet generally parallel to the first face sheet, and a metal foam core at least partially encapsulated between the first and second face sheets.

17. The brake pad assembly of claim 16, wherein the backing plate further comprises:
at least one margin region formed integrally with at least one of the first and second face sheets and positioned surrounding the metal foam core such that the at least one margin region and the first and second face sheets at least partially encapsulate the metal foam core.

18. The brake pad assembly of claim 16, wherein the metal foam core is chemically bonded to the first and second face sheets.

19. The brake pad assembly of claim 16, wherein a density of the metal foam core is less than or equal to 1 g/cm³.

20. The brake pad assembly of claim 16, wherein the metal foam core is an aluminum foam core.
